(19) United States
(12) Patent Application Publication
(10) Pub. No.: US 2010/0328340 A1
(43) Pub. Date: Dec. 30, 2010

(54) IMAGE PROCESSING DEVICE, IMAGE PROCESSING METHOD, AND IMAGE PROCESSING PROGRAM STORAGE MEDIUM

(75) Inventor: Hiroshi YANAGITA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/628,744

(22) Filed: Dec. 1, 2009

(30) Foreign Application Priority Data
Jun. 24, 2009 (JP) 2009-149853

(51) Int. Cl. G09G 5/02; G06K 9/00

(52) U.S. Cl. 345/590; 382/167; 358/1.9

(57) ABSTRACT

An image processing device including an input section, an image storage section, a storage area reserving section, a controller, and an output section is provided. The storage area reserving section reserves, when description data input via the input section indicates that a partial image including a transmission image is to be stored, a partial image area and an entire image area at the image storage section. The color space converter performs conversion using a first output color space conversion function that converts a description color space of the description data into an output color space that includes an entire image plane and a partial image plane. The controller converts the color-space converted partial image into an output image format and writes it in the partial image area, and converts the color-space converted entire image into an output image format and writes it in the entire image area.

### CROSS-REFERENCE TO RELATED APPLICATION

This application is based on and claims priority under 35 USC 119 from Japanese Patent Application No. 2009-149853 filed on Jun. 24, 2009.

### BACKGROUND

1. Technical Field

The present invention relates to an image processing device, an image processing method, and a computer readable storage medium that stores an image processing program.

2. Related Art

Conventionally, a method for generating a mask image at a pattern portion or a background portion other than the pattern portion and a method of generating a mask showing a desired color portion within a color image are proposed.

### SUMMARY

An aspect of the present invention is an image processing device including: an input section that receives description data expressing an entire image in accordance with predetermined rules; an image storage section; a storage area reserving section that, when the description data indicates that a partial image including a transmission image that of a transparent color is to be stored, reserves, at the image storage section, a partial image area that stores the partial image, and an entire image area that stores the entire image that includes the partial image; a color space converter that, when the partial image is to be stored, carries out conversion using a first output color space conversion function that converts a description color space of the description data into an output color space that includes an entire image plane and a partial image plane; a controller that effects control so as to convert the color-space converted partial image into an output image format and write a component of the partial image plane in the partial image area, and convert the color-space converted entire image into an output image format and write a component of the entire image plane in the entire image area; and an output section outputting the entire image stored in the entire image area.

### BRIEF DESCRIPTION OF THE DRAWINGS

Exemplary embodiments of the present invention will be described in detail based on the following figures, wherein:

FIG. 1 is a block diagram showing an example of the schematic structure of an image processing device relating to an exemplary embodiment;

FIG. 2 is a flowchart showing an example of processing executed at a PDL interpreter of the image processing device relating to the exemplary embodiment;

FIG. 3 is a drawing explaining an example of PDL data relating to the exemplary embodiment;

FIG. 4 is a drawing explaining an example of an output image relating to the exemplary embodiment;

FIG. 5 is a drawing explaining an example of a partial image relating to the exemplary embodiment;

FIG. 6 is a drawing explaining an example of processing that overlaps the partial image on the output image, relating to the exemplary embodiment;

FIG. 7 is a drawing explaining an example of usual color space conversion functions used in color space conversion in a usual mode, and trace color space conversion functions used in color space conversion in a trace mode;

FIG. 8 is a drawing explaining an example of PDL data relating to the exemplary embodiment;

FIG. 9 is a drawing explaining an example of an output image relating to the exemplary embodiment; and

FIG. 10 is a drawing explaining an example of an output image relating to the exemplary embodiment.

### DETAILED DESCRIPTION

An exemplary embodiment will be described in detail hereinafter with reference to the drawings. Note that “output image” in the present exemplary embodiment means an image itself that is outputted from a video controller, and means the entire image including a partial image. Further, “transmission image” means an image that is formed by a transparent color that is specified in advance, i.e., a so-called mask image. In the present exemplary embodiment, as an example, white, that is the color of the background of a sheet that is used when forming an image on a recording medium, is used as the transparent color. However, the transparent color is not limited to the same, and may be another color. The partial image is an image that includes the transmission image, and is an image in which the plane, in which the transmission image is recorded, is added to the layer (plane) structure of the output image.

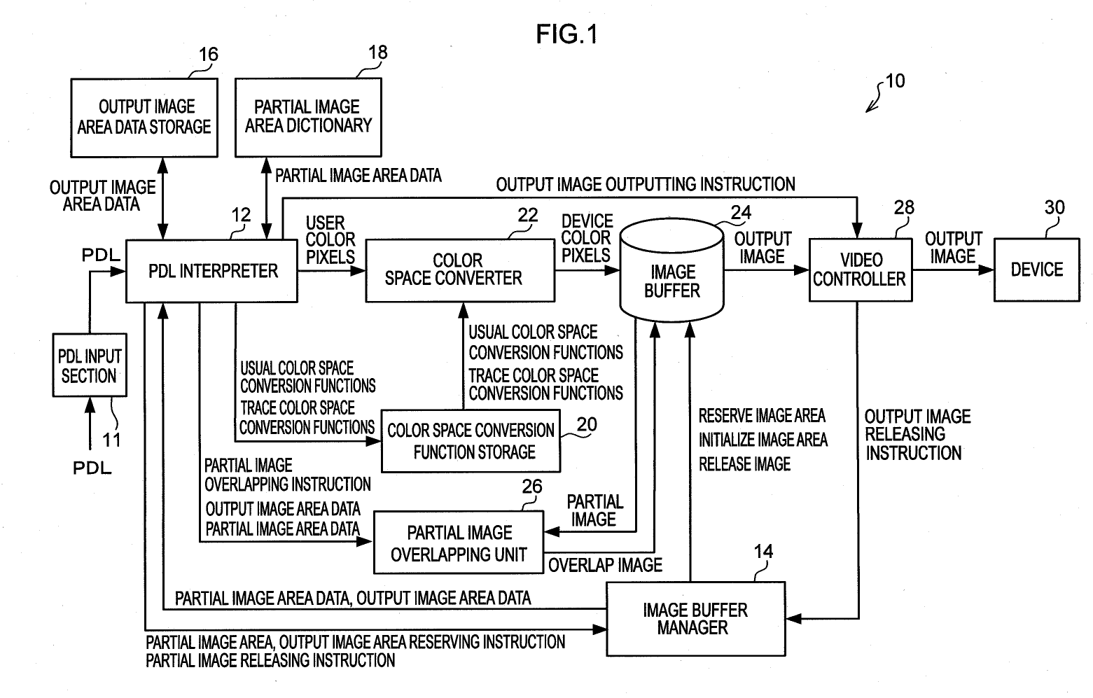

A block diagram showing an example of the schematic structure of an image processing device 10 relating to the exemplary embodiment is shown in FIG. 1. The image processing device 10 of the present exemplary embodiment is an image processing device that carries out a Raster Image Process that converts PDL data, that describes an image in accordance with the rules of Page Description Language (PDL), into raster data expressing the image in a raster format, and outputs the raster data.

The image processing device 10 of the present exemplary embodiment is structured to have a PDL input section 11, a PDL interpreter 12, an image buffer manager 14, an output image area data storage 16, a partial image area dictionary 18, a color space conversion function storage 20, a color space converter 22, an image buffer 24, a partial image overlapping unit 26, a video controller 28, and a device 30.

The PDL input section 11 receives inputted PDL data (hereinafter, “PDL data” will simply be called “PDL”). An input interface or the like is an example of the PDL input section 11. The PDL input section 11 may receive the PDL via a line such as a cable or the like from an external device, or may read PDL that has been hand-written by a user.

The image buffer manager 14 reserves, at the image buffer 24, a partial image area for storing a partial image and an output image area for storing an output image, and initializes these areas. When a partial image is to be stored (the trace mode that will be described later), due to an instruction from the PDL interpreter 12, the image buffer manager 14 reserves a partial image area and an output image area. Further, when a partial image is not to be stored (the usual mode that will be described later), due to an instruction from the PDL interpreter 12, the image buffer manager 14 reserves an output image area and does not reserve a partial image area.

The image buffer manager 14 releases the respective output image area and partial image area.

The output image area data storage 16 stores information (data) on the output image area, that is reserved by the image buffer manager 14, of the image buffer 24 in which the raster data of the output image is currently loaded. In the present exemplary embodiment, as an example, the start address and end address of that output image area, and the number of pixels in the scanning direction of the video controller 28, are stored.

The partial image area dictionary 18 stores information (data) on the partial image area for storing the partial image, which partial image area is reserved by the image buffer manager 14, in association with data (e.g., a partial image identification ID) that indicates that partial image that is instructed by the PDL. In the present exemplary embodiment, as an example, the start address and end address of that partial image area, and the number of pixels in the scanning direction of the video controller 28, are stored.

The color space conversion function storage 20 stores usual color space conversion functions for converting the user colors, that are the color space of the PDL inputted in the usual mode, into a raster image having plural planes that express the device colors that are the color space that the device 30 that is the output destination supports. Further, the color space conversion function storage 20 stores trace color space conversion functions for converting the user colors, that are inputted in the case of the trace mode, into a raster image having plural planes for the output image area and plural planes for the partial image area, that express the device colors, and one plane that holds the transmission data of the partial image. Note that the present exemplary embodiment describes, as an example, a case in which the user colors are RGB and the device colors are CMYK. However, the user colors and the device colors are not limited to these, and may be other color spaces.

The color space converter 22 converts the user colors (the color values in the color space) into the device colors in accordance with color space conversion functions stored in the color space conversion function storage 20. In the case of the usual mode, the color space converter 22 converts the color space by the usual color space conversion functions, and, in the case of the trace mode, the color space converter 22 converts the color space by the trace color space conversion functions.

The image buffer 24 stores the partial image that has been converted into raster data in the partial image area reserved by the image buffer manager 14, and stores the output image that has been converted into raster data in the output image area. Note that, in the present exemplary embodiment, a partial image and an output image are stored in the image buffer 24. However, the present invention is not limited to the same, and the images may be stored in another storage element such as a memory other than the image buffer, a RAM or the like.

On the basis of the mask pattern of the transmission image, the partial image overlapping unit 26 overlays, on the output image, the partial image that is stored in the partial image area of the image buffer 24, and loads, in the output image area, the raster data of the output image in a clipped state (the overlapped image).

The video controller 28 scans the output image area of the image buffer 24, and outputs video signals expressing the output image stored in the output image area, and transmits them to the device 30.

On the basis of the video signals received from the video controller 28, the device 30 outputs the output image at a printer or displays the output image on a medium such as a monitor, a control panel, or the like. Note that the present exemplary embodiment is structured such that the output image is output or displayed at the device 30. However, the present invention is not limited to the same, and the output image may be outputted onto a recording medium such as a sheet or the like by an image forming device or the like. Further, although the output image is displayed on the device 30 that is provided at the image processing device 10 in the present exemplary embodiment, the present invention is not limited to the same. The output image may be written to a file, outputted to an external device such as a user computer or the like, and displayed on the external device.

The PDL interpreter 12 interprets the inputted PDL, and instructs (as will be described in detail later) and controls the image buffer manager 14, the color space converter 22, the partial image overlapping unit 26, and the video controller 28. Further, the PDL interpreter 12 causes the usual color space conversion functions and the trace color space conversion functions to be stored in advance in the color space conversion function storage 20. Note that the PDL interpreter 12 is stored in an unillustrated ROM or the like, and is executed by an unillustrated CPU.

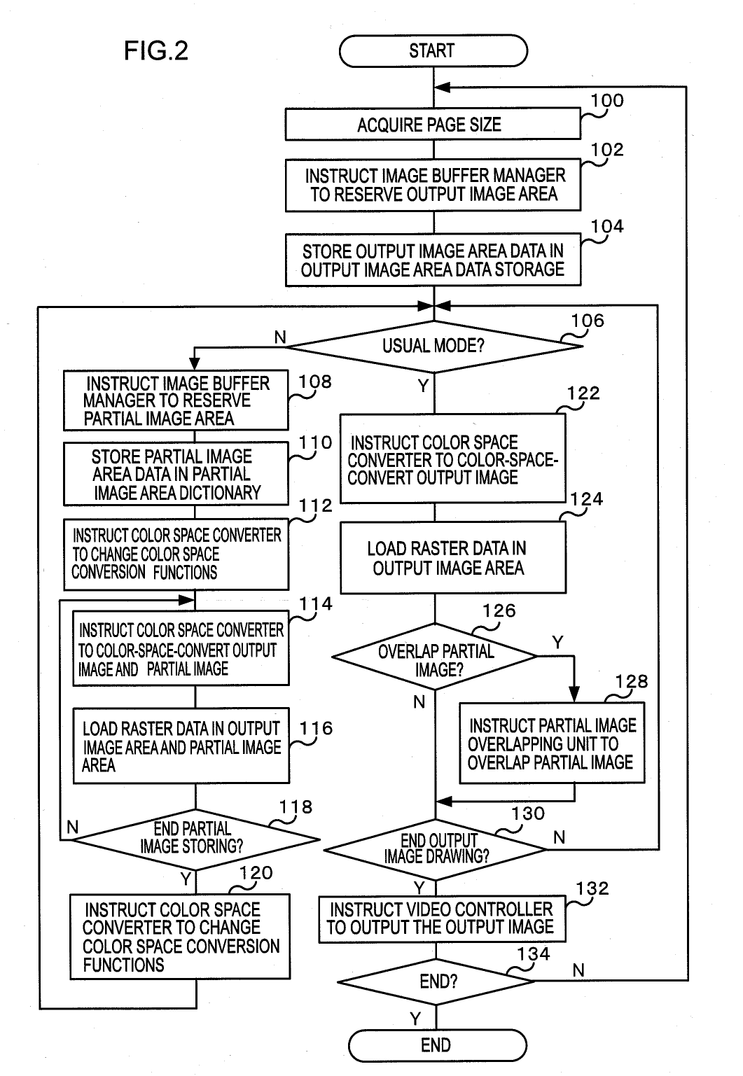

The processing executed at the PDL interpreter 12 will be described in detail. FIG. 2 is a flowchart showing an example of the processing executed at the PDL interpreter 12. The present processing is executed when the PDL input section 11 of the image processing device 10 receives PDL, and the PDL is inputted to the PDL interpreter 12.

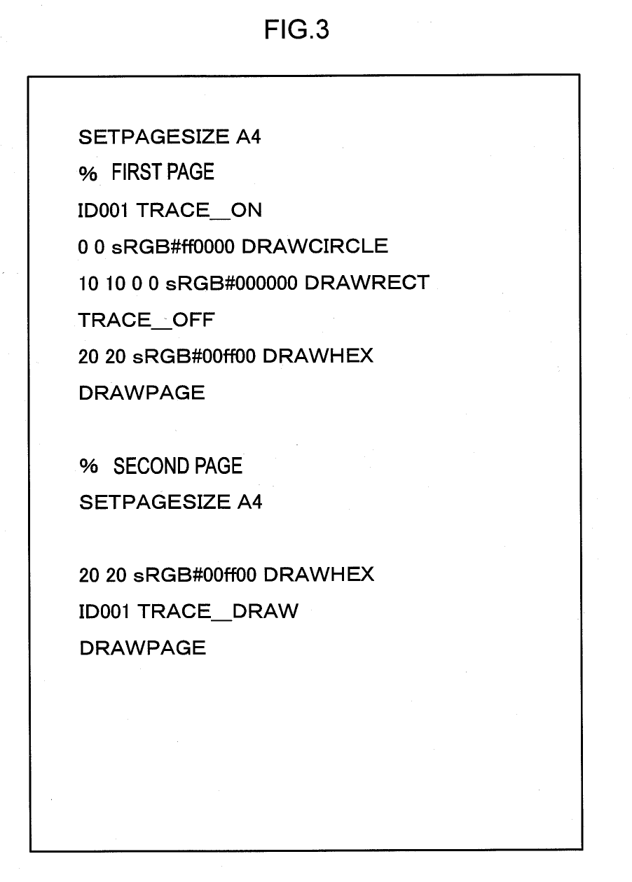

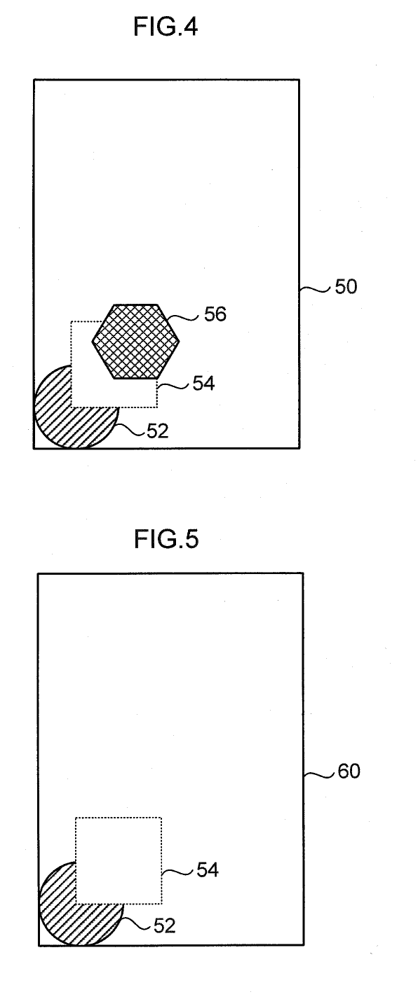

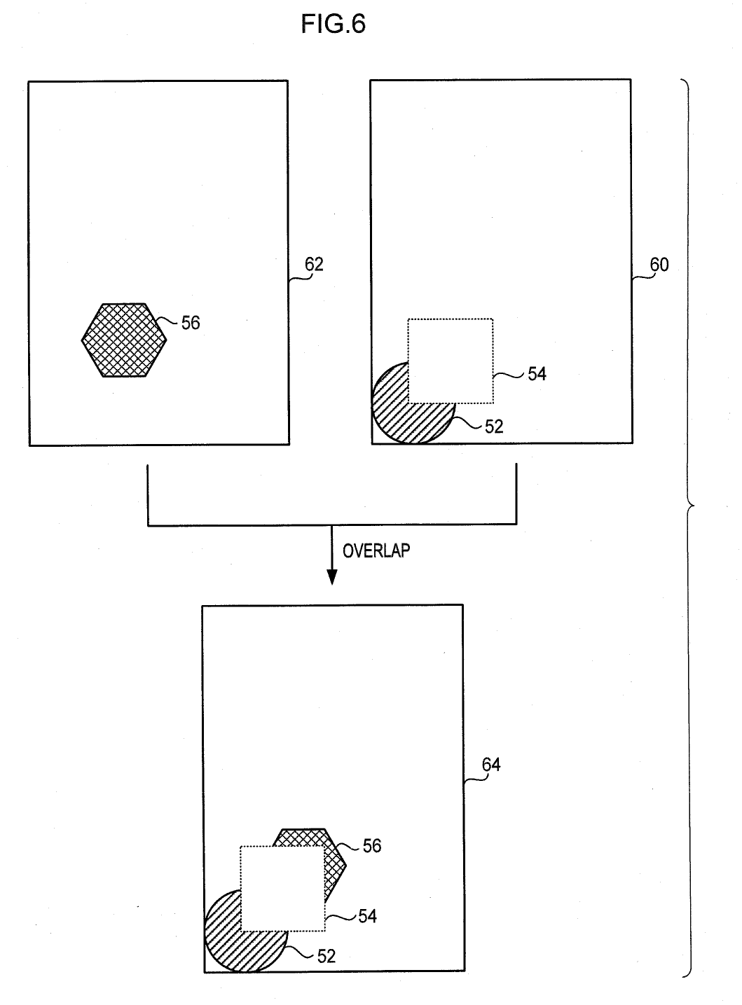

In step 100, the inputted PDL is interpreted, and the size of the output image is acquired. An example of the inputted PDL is shown in FIG. 3. Further, examples of the image (the output image) formed by this PDL are shown in FIG. 4 and FIG. 6, and examples of the partial image are shown in FIG. 5 and FIG. 6.

On the basis of the command “SETPAGESIZE. A4” in the PDL, A4 size is acquired (identified) as the size of the output image.

In step 102, the PDL interpreter 12 instructs the image buffer manager 14 to reserve an output image area of the acquired size (A4 size). Due to this instruction, the image buffer manager 14 reserves and initializes an A4-size output image area at the image buffer 24. Further, the image buffer manager 14 outputs the information (data) of the reserved output image area to the PDL interpreter 12.

In step 104, the data of the output image area that is inputted from the image buffer manager 14 is stored in the output image area data storage 16.

In step 106, it is determined whether the mode is the usual mode or the trace mode. In the present exemplary embodiment, if a command “TRACE_ON” is detected in the PDL, it is determined that the mode is the trace mode. If it is not detected, it is determined that the mode is the usual mode. In the example of the PDL shown in FIG. 3, “ID001 TRACE_ON” is a command to store the partial image with the identifier ID001 for identifying the partial image.

If the mode is determined to be the trace mode, the determination in step 106 is negative, and the routine proceeds to step 108.

In step 108, the PDL interpreter 12 instructs the image buffer manager 14 to reserve a partial image area. Due to this instruction, the image buffer manager 14 reserves and initializes a partial image area of the same size as the output image (A4 size in the present exemplary embodiment), at the image buffer 24. Further, the image buffer manager 14 outputs the data of the reserved partial image area to the PDL interpreter 12.

In step 110, the data of the partial image area inputted from the image buffer manager 14, and the identifier for identifying the partial image stored in that partial image area, are stored in correspondence with one another in the output image area data storage 16.

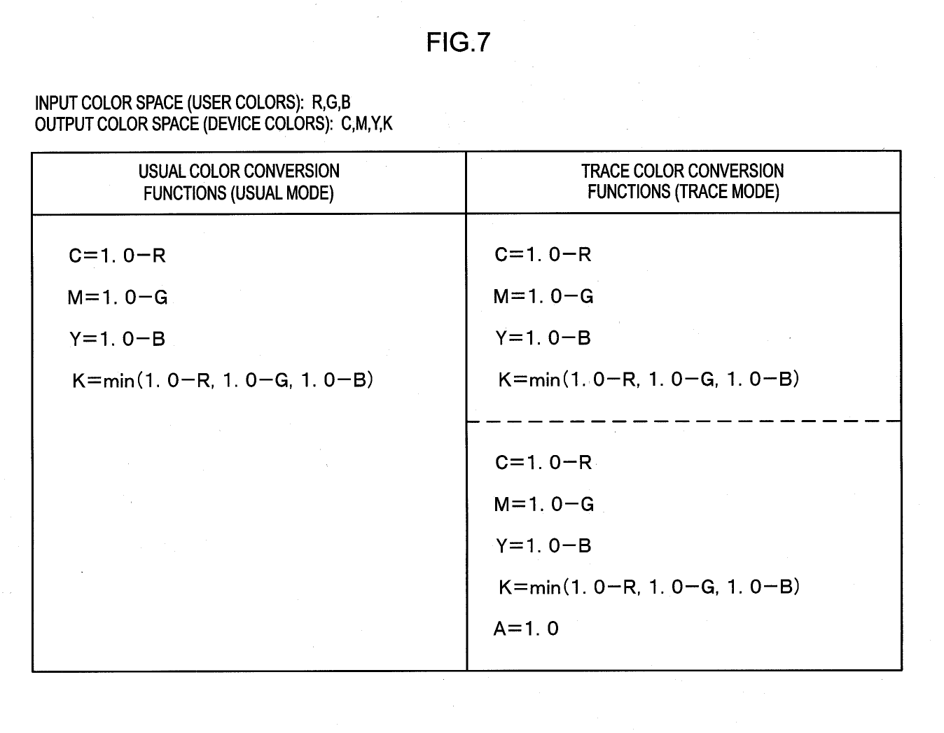

In step 112, the PDL interpreter 12 instructs the color space converter 22 to change the color space conversion functions that are used in color conversion to the trace color space conversion functions. In next step 114, the PDL interpreter 12 instructs the color space converter 22 to convert the color space of the output image and the partial image. Due to this instruction, the color space converter 22 reads-out the trace color space conversion functions from the color space conversion function storage 20, and converts the color values of the pixels from the user colors to the device colors by using the read-out trace color space conversion functions. Examples of the usual color space conversion functions and the trace color space conversion functions of the present exemplary embodiment are shown in FIG. 7. In the present exemplary embodiment, because the user colors are the three colors of RGB and the device colors are the four colors of CMYK, the usual mode has four color space conversion functions in order to convert the color space of the output image. Further, the trace mode has a total of nine color space conversion functions that are four color space conversion functions for converting the color space of the output image, and four color space conversion functions, that are similar to those for the output image, for converting the color space of the partial image, and a color space conversion function of the transmission color for the transmission image.

In step 116, the output image whose color space has been converted is converted into raster format and stored in the output image area of the image buffer 24, and the partial image whose color space has been converted is converted into raster format and stored in the partial image area.

In step 118, it is determined whether or not storing of the partial image is to be ended. If a command “TRACE OFF” is detected in the PDL shown in FIG. 3, it is determined that storing of the partial image is to be ended and the trace mode is to be ended. If it is not detected, it is determined that the storing of the partial image is not to be ended.

If it is determined that the storing of the partial image is not to be ended, the determination in step 118 is negative, the routine returns to step 114, and the processings of steps 114 through 118 are repeated. On the other hand, when it is determined that storing of the partial image is to be ended, the determination of step 118 is affirmative, and the routine proceeds to step 120.

In accordance with the processings of above steps 112 through 118, due to a command “0 0 sRGB#ff0000 DRAWCIRCLE” in the example of the PDL shown in FIG. 3, the raster data of a circle image 52 in an output image 50 shown in FIG. 4 is loaded in the output image area, and similarly, the raster data of the circle image 52 in a partial image 60 shown in FIG. 5 is loaded in the partial image area. Note that, in the present exemplary embodiment, this is carried out by copying, to the partial image area, the raster data of the output image loaded at the output image area. Further, due to a command “10 10 0 0 sRGB#000000 DRAWRECT”, the raster data of a quadrangular image 54 in the output image 50 shown in FIG. 4 is loaded in the output image area, and similarly, the raster data of the quadrangular image 54 in the partial image 60 shown in FIG. 5 is loaded in the partial image area. Note that, in FIG. 4 and FIG. 5, the outline of the quadrangular image 54 is shown by a dotted line. However, the quadrangular image 54 is a transmission image, and in the present exemplary embodiment, is white that is the same color as the background of the sheet used when outputting the image onto a recording medium. Therefore, when the image is outputted on the sheet, the dotted line showing the outline is not displayed.

In this way, the partial image 60 whose identifier is ID001 is stored in the partial image area of the image buffer 24 by the processings of above-described steps 114 through 118.

On the other hand, in step 120 that is when the determination in step 118 is affirmative, the PDL interpreter 12 instructs the color space converter 22 to change the color space conversion functions used in color space conversion to the usual color space conversion functions, and thereafter, the routine returns to step 106. Due to the color space converter 22 switching the color space conversion functions that are used to the usual color space conversion functions due to this instruction, preparations are made for color space conversion in the usual mode.

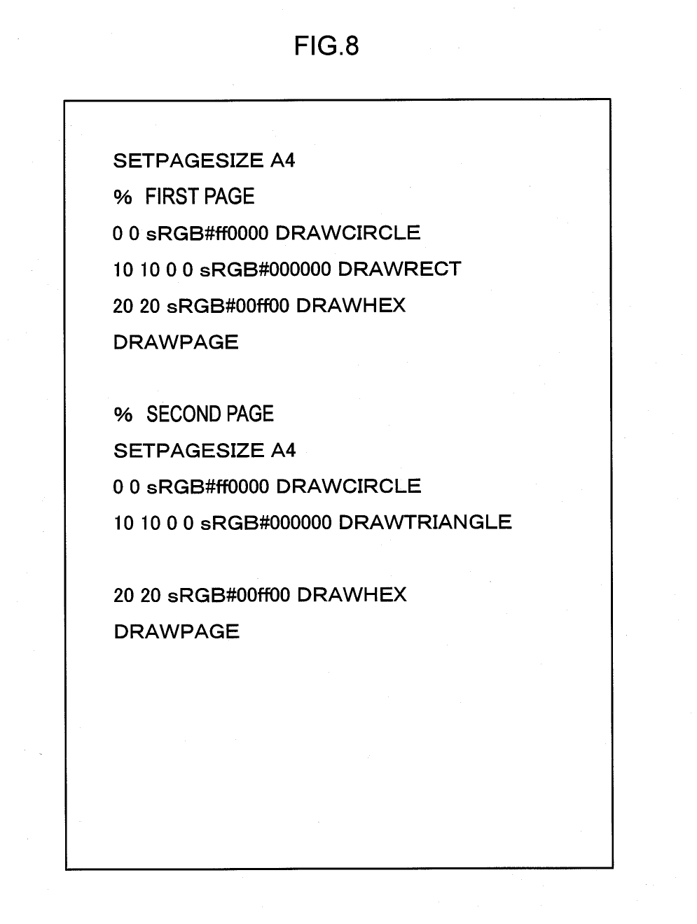

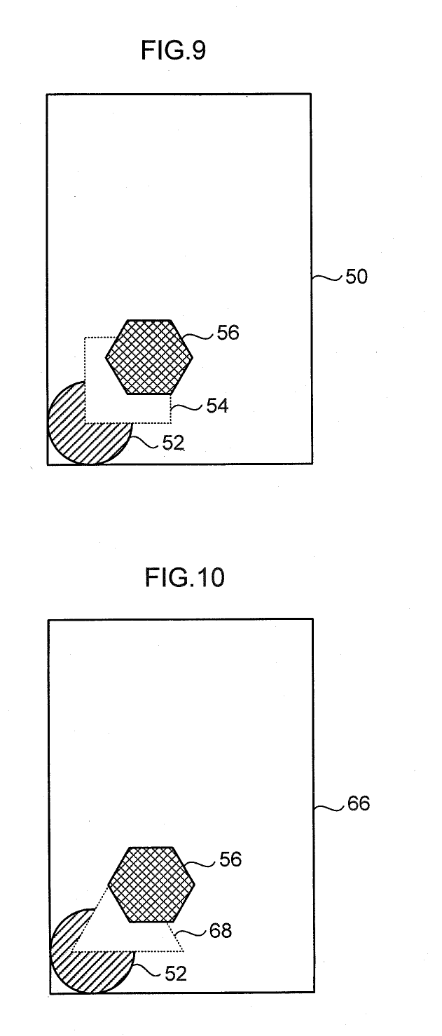

Further, if the mode is determined to be the usual mode in step 106, the judgment is affirmative, and the routine moves on to step 122. Note that the usual mode of the present exemplary embodiment has three cases that are a case of executing a command after the trace mode of the first page of the PDL shown in FIG. 3 has ended, and a case in which the output image and the partial image stored in the partial image area are overlapped as shown in the second page of the PDL shown in FIG. 3 and are stored in a clipped state in the output image area, and a case in which the output image, that is converter into raster data without taking the partial image into consideration, is stored in the output image area (a case in which the PDL is as shown in FIG. 8 that will be described in detail later).

In step 122, the PDL interpreter 12 instructs the color space converter 22 to convert the color space of the output image. Due to this instruction, the color space converter 22 reads-out the usual color space conversion functions from the color space conversion function storage 20, and, by using the read-out usual color space conversion functions, converts the color values of the pixels from the user colors into the device colors.

In next step 124, the output image whose color space has been converted is converted into raster format, and is stored in the output image area of the image buffer 24. After the end of the trace mode of the first page of the PDL shown in FIG. 3, due to the command “20 20 sRGB#00ff00 DRAWHEX”, the raster data of a hexagonal image 56 in the output image 50 shown in FIG. 4 is loaded in the output image area. Thus, the raster data of the output image 50 is stored in the output image area of the image buffer 24.

Further, in the case of the second page of the PDL shown in FIG. 3, due to the command “20 20 sRGB#00ff00 DRAWHEX”, the raster data of the hexagonal image 56 in an output image 62 shown in FIG. 6 is loaded in the output image area. Thus, the raster data of the output image 62 is stored in the output image area of the image buffer 24.

In next step 126, it is determined whether or not a partial image is to be overlapped on the output image. If the command “TRACE_DRAW” is detected in the PDL shown in FIG. 3, it is determined that a partial image is to be overlapped, and, if not detected, it is determined that a partial image is not to be overlapped. In the example of the PDL shown in FIG. 3, “ID001 TRACE_DRAW” is a command to overlap the partial image whose identifier is ID001.

If a partial image is to be overlapped, the determination in step 126 is affirmative, and the routine moves on to step 128. In step 128, the PDL interpreter 12 instructs the partial image overlapping unit 26 to overlap the partial image. Further, the PDL interpreter 12 reads-out the data of the partial image area corresponding to the identifier ID001 from the partial image area dictionary 18, and reads-out, from the output image area data storage 16, the data of the output image area in which the raster data was loaded in step 124, and outputs these data to the partial image overlapping unit 26. The partial image overlapping unit 26 generates an output image in which the partial image, that is based on the data of the partial image area inputted from the PDL interpreter 12, is clipped to the output image that is based on the data of the output image area, and the partial image overlapping unit 26 stores the generated output image in the output image area. In the present exemplary embodiment, as shown in FIG. 6, the partial image 60 is overlapped on the output image 62, and the resulting image is stored as output image 64 in the output image area of the image buffer 24.

If the determination in step 126 is negative, or if step 128 is completed, in step 130 it is determined whether or not drawing of the output image is to be ended. If the command “DRAWPAGE” is detected in the PDL shown in FIG. 3, it is determined that drawing of the output image is to be ended, and, if this command is not detected, it is determined that drawing of the output image is not to be ended.

If drawing of the output image is not to be ended, the determination in step 130 is negative, the routine returns to step 106, and the processings of step 106 through step 128 are repeated until a drawing end command is detected. On the other hand, if drawing of the output image is to be ended, the determination is affirmative, and the routine moves on to step 132.

In step 132, by outputting the output image area to the video controller 28 and giving notice of the end of loading of the raster data of the output image to the output image area, the PDL interpreter 12 instructs the video controller 28 outputting of the output image. Due to this instruction, the video controller 28 scans the instructed output image area of the image buffer 24, generates video signals, and outputs the generated video signals to the device 30. The resultant output image (the output image 50, 64) is thereby displayed on the device 30.

In step 134, it is determined whether or not the present processing is to be ended. If pages on which the present processing (step 100 through step 132) has not been carried out remain in the PDL, the determination is negative, the routine returns to step 100, and the present processing is repeated. On the other hand, if the present processing has been carried out with respect to all of the pages, the determination is affirmative, and the present processing is ended.

Note that, if an output image, that has been converted into raster data without taking the partial image into consideration, is stored in the output image area as is the case of the PDL shown in FIG. 8, the mode is the usual mode, and overlapping of a partial image is not carried out. Therefore, the processings of step 108 through step 120, and of step 128, are not carried out. In the case of the PDL shown in FIG. 8, in the first page, the output image 50 in which are formed the circular image 52, the hexagonal image 56, and the quadrangular image 54 that is the transmission image, is displayed on the device 30. Further, in the second page, an output image 66 in which are formed the circular image 52, the hexagonal image 56 and a triangular image 68 that is a transmission image, is displayed on the display 30.

The partial image that is stored in the partial image area of the image buffer 24 by the present processing may, after the present processing ends, be deleted from the image buffer 24 (the image buffer manager 24 may release the partial image), or, even after the present processing ends, may be stored and may be used again when the present processing is executed again. Further, the partial image may be deleted in predetermined cases, such as when the user instructs deletion, or when the image buffer 24 becomes full, or the like.

FIG. 3 and FIG. 8 are shown as examples of PDL in the present exemplary embodiment, but the present invention is not limited to these. Further, it suffices to use predetermined commands for commands to store the partial image, commands to end storing of the partial image, and the like.

The present exemplary embodiment describes a case of processing (generating) an image described in PDL. However, the present invention is not limited to the same, and is not particularly limited provided that there is description data in which an image is described.

In the present exemplary embodiment, the image, that is between the command to store the partial image (“TRACE_ON”) and the command to end storage of the partial image (“TRACE OFF”), is loaded as a partial image in the partial image area of the image buffer 24, and is stored. However, the present invention is not limited to the same. An inputted PDL may be interpreted at the PDL interpreter 12, an image that is repeatedly used may be selected as a partial image, and the selected image may be loaded in the partial image area and stored.

The present exemplary embodiment describes a case in which one partial image (the partial image whose identifier=ID001) is stored with respect to the output image of one page. However, the present invention is not limited to the same, and plural partial images may be stored by differing the respective identifiers.

The present exemplary embodiment may be realized by a computer-readable storage medium on which is stored a program for causing a computer to operate as the PDL interpreter.

As described above, at the image processing device 10 of the exemplary embodiment, the PDL interpreter 12 interprets an inputted PDL, and when a command to store a partial image in the image buffer 24 is detected (the trace mode), the PDL interpreter 12 instructs the image buffer manger 14 to reserve a partial image area and an output image area at the image buffer 24. Further, the PDL interpreter 12 instructs the color space converter 22 to convert the user colors of the partial image and the output image into the device colors by using the trace color space conversion functions that are stored in the color space conversion function storage 20. Moreover, the partial image, whose color space has been converted by the color space converter 22, is converted into raster data and stored in the partial image area, and the output image is converted into raster data and stored in the output image area. Due to the instruction of the PDL interpreter 12, the video controller 28 outputs, to the device 30, video signals of the output image stored in the output image area, and the device 30 displays the output image on the basis of the inputted video signals.

In the case of the usual mode, the image buffer manager 14 reserves only the output image area at the image buffer 24. The color space converter 22 converts the user colors into the device colors by using the usual color space conversion functions that are stored in the color space conversion function storage 20. The converted output image is converted into raster data and stored in the output image area. When the PDL interpreter 12 detects a command to overlap a partial image, the PDL interpreter 12 reads-out the partial image stored in the partial image area of the image buffer 24, on the basis of the partial image area data that is read-out from the partial image area dictionary 18 and that corresponds to the identifier of the partial image for which overlapping is instructed, and overlaps (clips) the partial image to the output image, and stores the resulting image in the output image area.

Due thereto, the partial image that has been converted into raster data will be stored in the partial image area of the image buffer 24, and therefore, overlapping of the partial image is made to be efficient. Because the load arising at the time of generating the raster data is reduced in this way, the RIP performance of the image processing device 10 improves.

Further, in the case of the usual mode, only the output image area is reserved, and only the output image is color-space-converted and converted into raster data. Therefore, the capacity that the image buffer 24 uses (the reserved area) is suppressed, and processing is made more efficient.

Due to the usual color space conversion functions and the trace color space conversion functions being stored in the color space conversion function storage 20, the color space converter 22 can carry out color space conversion by using stored color space conversion functions, and therefore, the processing of the color space conversion is made to be more efficient.

Because the data, that expresses the partial image area, and the identifier of the partial image are stored in the partial image area dictionary 18 in correspondence with one another, the processing of the partial image overlapping unit 26 when overlapping the partial image is made more efficient.

What is claimed is:

1. An image processing device comprising:
an input section that receives description data expressing an entire image in accordance with predetermined rules;
an image storage section;
a storage area reserving section that, when the description data indicates that a partial image including a transmission image that comprises a transparent color is to be stored, reserves, at the image storage section, a partial image area that stores the partial image, and an entire image area that stores the entire image that includes the partial image;
a color space converter that, when the partial image is to be stored, carries out conversion using a first output color space conversion function that converts a description color space of the description data into an output color space that includes an entire image plane and a partial image plane;
a controller that effects control so as to convert the color-space converted partial image into an output image format and write a component of the partial image plane in the partial image area, and convert the color-space converted entire image into an output image format and write a component of the entire image plane in the entire image area; and
an output section outputting the entire image stored in the entire image area.

2. The image processing device of claim 1, wherein when the description data indicates that the partial image is not to be stored, the storage area reserving section reserves only the entire image area.

3. The image processing device of claim 1, further comprising:
a color space conversion function storage section that stores the first output color space conversion function, and a second output color space conversion function that converts a description color space of the description data into an output color space that includes only an entire image plane,
wherein, when the partial image is to be stored, the color space converter converts the description color space using the first output color space conversion function, and, when the partial image is not to be stored, the color space converter converts the description color space using the second output color space conversion function.

4. The image processing device of claim 3, wherein, when the description data indicates that the partial image is to be stored, the controller instructs the color space converter to convert the description color space using the first output color space conversion function, and, when the partial image is not to be stored, the controller instructs the color space converter to convert the description color space using the second output color space conversion function.

5. The image processing device of claim 3, further comprising:
an overlapping unit that overlaps the partial image, that is stored in the partial image area, and a predetermined image described in the description data, and stores a resulting image in the entire image area,
wherein, when the description data indicates that the partial image and the predetermined image are to be overlapped, the controller instructs the color space converter to convert the description color space of the entire image using the second output color space conversion function, and converts the predetermined image, whose color space has been converted, into an output image format, and instructs the overlapping unit to overlap the predetermined image and the partial image.

6. The image processing device of claim 5, further comprising:
a partial image area data storage section that stores partial image area data expressing the partial image area in which the partial image is stored,
wherein the overlapping unit overlaps the partial image, that is stored in the partial image area expressed by the partial image area data, and the predetermined image.

7. A computer-readable storage medium storing a program that causes an image processing device to execute image processing, the image processing comprising:
receiving description data expressing an entire image in accordance with predetermined rules;
when the description data indicates that a partial image including a transmission image that comprises a transparent color is to be stored in an image storage section, reserves, at the image storage section, a partial image area that stores the partial image, and an entire image area that stores the entire image that includes the partial image;
when the partial image is to be stored, carrying out conversion using a first output color space conversion function that converts a description color space of the description data into an output color space that includes an entire image plane and a partial image plane;
converting, the color-space converted partial image into an output image format and writing a component of the partial image plane in the partial image area, and converting the color-space converted entire image into an output image format and writing a component of the entire image plane in the entire image area; and
outputting the entire image stored in the entire image area.

8. An image processing method comprising:
receiving description data expressing an entire image in accordance with predetermined rules;
when the description data indicates that a partial image including a transmission image that comprises a transparent color is to be stored in an image storage section, reserving, at the image storage section, a partial image area that stores the partial image and an entire image area that stores the entire image that includes the partial image;
when the partial image is to be stored, carrying out conversion using a first output color space conversion function that converts a description color space of the description data into an output color space that includes an entire image plane and a partial image plane;
converting, the color-space converted partial image into an output image format and writing a component of the partial image plane in the partial image area, and converting the color-space converted entire image into an output image format and writing a component of the entire image plane in the entire image area; and
outputting the entire image stored in the entire image area.
